(19) United States
(12) Patent Application Publication
(10) Pub. No.: US 2022/0103820 A1
(43) Pub. Date: Mar. 31, 2022

(54) ENCODER, DECODER, METHODS AND COMPUTER PROGRAMS WITH AN IMPROVED TRANSFORM BASED SCALING

(71) Applicant: Fraunhofer-Gesellschaft zur Förderung der angewandten Forschung e.V., München (DE)

(72) Inventors: Benjamin BROSS, Berlin (DE); Phan Hoang Tung NGUYEN, Berlin (DE); Heiko SCHWARZ, Berlin (DE); Detlev MARPE, Berlin (DE); Thomas WIEGAND, Berlin (DE)

(21) Appl. No.: 17/547,937

(22) Filed: Dec. 10, 2021

Related U.S. Application Data
(63) Continuation of application No. PCT/EP2020/066355, filed on Jun. 12, 2020.

(30) Foreign Application Priority Data
Jun. 14, 2019 (EP) 19180322.0

(51) Int. Cl. H04N 19/12; H04N 19/124; H04N 19/13; H04N 19/147; H04N 19/159; H04N 19/176

(52) U.S. Cl. CPC H04N 19/12; H04N 19/124; H04N 19/176; H04N 19/147; H04N 19/159; H04N 19/13

(57) ABSTRACT

Decoder for block-based decoding of an encoded picture signal using transform decoding, configured to select for a predetermined block a selected transform mode, entropy decode a block to be dequantized, which is associated with the predetermined block according to the selected transform mode, from a data stream and dequantize the block to be dequantized using a quantization accuracy, which depends on the selected transform mode, to obtain a dequantized block.

### CROSS-REFERENCES TO RELATED APPLICATIONS

This application is a continuation of copending International Application No. PCT/EP2020/066355, filed Jun. 12, 2020, which is incorporated herein by reference in its entirety, and additionally claims priority from European Application No. EP 19 180 322.0, filed Jun. 14, 2019, which is/all of which are incorporated herein by reference in its/their entirety.

### BACKGROUND OF THE INVENTION

Embodiments according to the invention related to an encoder, a decoder, methods and computer programs with an improved transform based scaling.

In the following, different inventive embodiments and aspects will be described. Also, further embodiments will be defined by the enclosed claims.

It should be noted that any embodiments as defined by the claims can be supplemented by any of the details (features and functionalities) described in the following different inventive embodiments and aspects.

Also, it should be noted that individual aspects described herein can be used individually or in combination. Thus, details can be added to each of said individual aspects without adding details to another one of said aspects.

It should also be noted that the present disclosure describes, explicitly or implicitly, features usable in an encoder (apparatus for providing an encoded representation of an input signal) and in a decoder (apparatus for providing a decoded representation of a signal on the basis of an encoded representation). Thus, any of the features described herein can be used in the context of an encoder and in the context of a decoder.

Moreover, features and functionalities disclosed herein relating to a method can also be used in an apparatus (configured to perform such functionality). Furthermore, any features and functionalities disclosed herein with respect to an apparatus can also be used in a corresponding method. In other words, the methods disclosed herein can be supplemented by any of the features and functionalities described with respect to the apparatuses.

Also, any of the features and functionalities described herein can be implemented in hardware or in software, or using a combination of hardware and software, as will be described in the section “implementation alternatives”.

In state-of-the-art lossy video compression, the encoder quantizes the prediction residual or the transformed prediction residual using a specific quantization step size Δ. The smaller the step size, the finer the quantization and the smaller the error between original and reconstructed signal. Recent video coding standards (such as H.264 and H.265) derive that quantization step size Δ using an exponential function of a so-called quantization parameter (QP), e.g.:

$$Δ ( Q P ) \approx const \cdot {2}^{\frac{Q P}{6}}$$

The exponential relationship between quantization step size and quantization parameter allows a finer adjustment of the resulting bit rate. The decoder needs to know the quantization step size to perform the correct scaling of the quantized signal. This stage is sometimes referred to as “inverse quantization” although quantization is irreversible. That is why the decoder parses the scaling factor or QP from the bitstream. The QP signalling is typically performed hierarchically, i.e. a base QP is signalled at a higher level in the bitstream, e.g. at picture level. At sub-picture level, where a picture can consist of multiple slices, tiles or bricks, only a delta to the base QP is signalled. In order to adjust the bitrate at an even finer granularity, a delta QP can even be signalled per block or area of blocks, e.g. signaled in one transform unit within an N×N area of coding blocks in HEVC. Encoders usually use the delta QP technique for subjective optimization or rate-control algorithms. Without loss of generality, it is assumed in the following that the base unit in the presented invention is a picture, and hence, the base QP is signalled by the encoder for each picture consisting of a single slice. In addition to this base QP, also referred to as slice QP, a delta QP can be signalled for each transform block (or any union of transform block, also referred to as quantization group).

State-of-the-art video coding schemes, such as High Efficiency Video Coding (HEVC), or the upcoming Versatile Video Coding (VVC) standard, optimize the energy compaction of various residual signal types by allowing additional transforms beyond widely used integer approximations of the type II discrete cosine transform (DCT-II). The HEVC standard further specifies an integer approximation of the type-VII discrete sine transform (DST-VII) for 4×4 transform blocks using specific intra directional modes. Due to this fixed mapping, there is no need to signal whether DCT-II or DST-VII is used. In addition to that, is the identity transform can be selected for 4×4 transform blocks. Here the encoder needs to signal whether DCT-II/DST-VII or identity transform is applied. Since the identity transform is the matrix equivalent to a multiplication with 1, it is also referred to as transform skip. Furthermore, the current VVC development allows the encoder to select more transforms of the DCT/DST family for the residual as well as additional non-separable transforms, which are applied after the DCT/DST transform at the encoder and before the inverse DCT/DST at the decoder. Both, the extended set of DCT/DST transforms and the additional non-separable transforms, need additional signalling per transform block.

FIG. 1b illustrates the hybrid video coding approach with forward transform and subsequent quantization of the residual signal 24 at the encoder 10, and scaling of the quantized transform coefficients followed by inverse transform for the decoder 36. The transform and quantization related blocks 28/32 and 52/54 are highlighted.

### SUMMARY

An embodiment may have an encoder for block-based encoding of a picture signal using transform coding, configured to: select for a predetermined block a selected transform mode; quantize a block to be quantized, which is associated with the predetermined block according to the selected transform mode, using a quantization accuracy, which depends on the selected transform mode, to acquire a quantized block; and entropy encode the quantized block into a data stream.

Another embodiment may have a decoder for block-based decoding of an encoded picture signal using transform decoding, configured to: select for a predetermined block a selected transform mode; entropy decode a block to be dequantized, which is associated with the predetermined block according to the selected transform mode, from a data stream; dequantize the block to be dequantized using a quantization accuracy, which depends on the selected transform mode, to acquire a dequantized block.

Another embodiment may have a method for block-based encoding of a picture signal using transform coding, having the steps of: selecting for a predetermined block a selected transform mode; quantizing a block to be quantized, which is associated with the predetermined block according to the selected transform mode, using a quantization accuracy, which depends on the selected transform mode, to acquire a quantized block; and entropy encoding the quantized block into a data stream.

Another embodiment may have a method for block-based decoding of an encoded picture signal using transform decoding, having the steps of: selecting for a predetermined block a selected transform mode; entropy decoding a block to be dequantized, which is associated with the predetermined block according to the selected transform mode, from a data stream; dequantizing the block to be dequantized using a quantization accuracy, which depends on the selected transform mode, to acquire a dequantized block.

Another embodiment may have a non-transitory digital storage medium having a computer program stored thereon to perform the method for block-based encoding of a picture signal using transform coding, having the steps of: selecting for a predetermined block a selected transform mode; quantizing a block to be quantized, which is associated with the predetermined block according to the selected transform mode, using a quantization accuracy, which depends on the selected transform mode, to acquire a quantized block; and entropy encoding the quantized block into a data stream, when said computer program is run by a computer.

Another embodiment may have a non-transitory digital storage medium having a computer program stored thereon to perform the method for block-based decoding of an encoded picture signal using transform decoding, having the steps of: selecting for a predetermined block a selected transform mode; entropy decoding a block to be dequantized, which is associated with the predetermined block according to the selected transform mode, from a data stream; dequantizing the block to be dequantized using a quantization accuracy, which depends on the selected transform mode, to acquire a dequantized block, when said computer program is run by a computer.

Another embodiment may have a data stream acquired by a method for block-based encoding of a picture signal using transform coding, having the steps of: selecting for a predetermined block a selected transform mode; quantizing a block to be quantized, which is associated with the predetermined block according to the selected transform mode, using a quantization accuracy, which depends on the selected transform mode, to acquire a quantized block; and entropy encoding the quantized block into a data stream.

Another embodiment may have a data stream acquired by a method for block-based decoding of an encoded picture signal using transform decoding, having the steps of: selecting for a predetermined block a selected transform mode; entropy decoding a block to be dequantized, which is associated with the predetermined block according to the selected transform mode, from a data stream; dequantizing the block to be dequantized using a quantization accuracy, which depends on the selected transform mode, to acquire a dequantized block.

In accordance with a first aspect of the present invention, the inventors of the present application realized that one problem encountered when quantizing transform coefficients and scaling quantized transform coefficients stems from the fact that different transform modes and/or block sizes can result in different scaling factors and quantization parameters. A quantization accuracy at one transform mode can lead to increased distortions at another transform mode. According to the first aspect of the present application, this difficulty is overcome by selecting a quantization accuracy dependent on the transform mode used for a block to be quantized. Thus, different quantization accuracies can be chosen for different transform modes and/or block sizes.

Accordingly, in accordance with a first aspect of the present application, an encoder for block-based encoding of a picture signal using transform coding, is configured to select for a predetermined block, e.g. a block in an area of blocks in a video signal or a picture signal, a selected transform mode, e.g. an identity transform or a non-identity transform. The identity transform can be understood as a transform skip. Furthermore, the encoder is configured to quantize a block to be quantized, which is associated with the predetermined block according to the selected transform mode, using a quantization accuracy, which depends on the selected transform mode, to obtain a quantized block. The block to be quantized, e.g., is the predetermined block subjected to the selected transform mode and/or a block obtained by applying a transform underlying the selected transform mode onto the predetermined block, in case of the selected transform mode being a non-identity transform, and by equalizing the predetermined block, in case of the selected transform mode being an identity transform. The quantization accuracy, for example, is defined by a quantization parameter (QP), a scaling factor and/or a quantization step size. Values of the block to be quantized, e.g., are divided by the quantization parameter (QP), the scaling factor and/or the quantization step size to receive the quantized block. Additionally, the encoder is configured to entropy encode the quantized block into a data stream.

Similarly, in accordance with a first aspect of the present application, a decoder for block-based decoding of an encoded picture signal using transform decoding, is configured to select for a predetermined block, e.g., a block in an area of blocks in the decoded picture signal or video signal, a selected transform mode, e.g., an identity transform or a non-identity transform. The identity transform can be understood as a transform skip. The non-identity transform can be an inverse/reverse transformation of the transformation applied by an encoder. Furthermore, the decoder is configured to entropy decode a block to be dequantized, which is associated with the predetermined block according to the selected transform mode, from a data stream. The block to be dequantized, e.g., is the predetermined block before subjected to the selected transform mode. Additionally, the decoder is configured to dequantize the block to be dequantized using a quantization accuracy, which depends on the selected transform mode, to obtain a dequantized block. The quantization accuracy, e.g., is defined by a quantization parameter (QP), a scaling factor and/or a quantization step size. Values of the block, e.g., are multiplied with the quantization parameter (QP), the scaling factor and/or the quantization step size to receive the dequantized block. The quantization accuracy, for example, defines an accuracy of the dequantization of the block to be dequantized. The quantization accuracy can be understood as a scaling accuracy.

According to an embodiment, the quantization accuracy depends partially on whether the selected transform mode is an identity transform or a non-identity transform. Note that further adaptations may occur depending on the prediction mode and/or the block size and/or the block shape. The dependence on transform mode is based on the idea that a non-identity transform may increase a precision of a residual signal whereby also the dynamic range can be increased. However, this is not the case for an identity transform. A quantization accuracy associated with a low distortion for non-identity transforms could lead to higher distortions in case of the transform mode being the identity transform. Thus, a distinction between the identity transform and non-identity transforms is advantageous.

If the selected transform mode is the identity transform, the encoder and/or the decoder can be configured to determine an initial quantization accuracy for the predetermined block and check whether the initial quantization accuracy is finer than a predetermined threshold. Although a finer quantization accuracy than the predetermined threshold can decrease distortions in case of the selected transform mode being the non-identity transform this is not the case for the selected transform mode being the identity transform. If the initial quantization accuracy is finer than the predetermined threshold, the encoder and/or the decoder can be configured, in case of the selected transform mode being the identity transform, to set the quantization accuracy to a default quantization accuracy, e.g., corresponding to the predetermined threshold. Thus additional distortions, not existing for the default quantization accuracy, can be avoided.

Additionally, the encoder and/or the decoder can be configured to, if the initial quantization accuracy is not finer than the predetermined threshold, use the initial quantization accuracy as the quantization accuracy. In this case the initial quantization accuracy should not introduce additional distortions, whereby it is no problem to use the initial quantization accuracy without change or adjustment.

According to an embodiment, the initial quantization accuracy is determined by determining an index out of a quantization parameter list, in case of the encoder, and out of a dequantization parameter list, in case of the decoder. The index, for example, points to a quantization parameter, e.g., a dequantization parameter or a scaling parameter for the decoder, within the quantization parameter list, e.g., the dequantization parameter list for the decoder, and is associated with, via a function equal for all quantization parameter in the quantization parameter list, a quantization step size. The encoder may be configured to, e.g., quantize by dividing values of the block to be quantized by the quantization step size and the decoder may be configured to dequantize by multiplying values of the block to be dequantized with the quantization step size. The index can be equal to a quantization parameter (QP) and the quantization parameter list and/or the dequantization parameter list can be defined by levelScale[ ]={40, 45, 51, 64, 72}. The quantization step size (Δ(QP)) can be derived using an exponential function of the index (QP), e.g.,

$$Δ ( Q P ) = \frac{{2}^{4} \cdot lev el Scal e [ Q P \% 6 ] \cdot 2 ⌊ \frac{Q P}{6} ⌋}{{2}^{10}} ,$$

wherein levelScale[ ]={40, 45, 51, 64, 72}.

According to an embodiment, the encoder and/or the decoder is configured to check whether the initial quantization accuracy is finer than the predetermined threshold by checking whether the index, i.e. the index out of the quantization parameter list, is smaller than a predetermined index value. The predetermined index value defines, for example, an index of four, i.e. the index equals four. The encoder and/or the decoder can be configured to clip the index, e.g., a quantization parameter QP, to a minimum value of four, if the selected transform mode is the identity transform. The encoder and/or the decoder can be configured to prohibit a quantization parameter (QP) smaller than 4. If the QP is smaller than four, the encoder and/or the decoder can be configured to set the QP to four and if the QP is four or greater, the QP is maintained, e.g., is Trafo Skip? Max(4, QP): QP. Thus indices, e.g., QPs 0, 1, 2 and 3, resulting in a scaling factor smaller than 1, which could introduce distortions in the transform skip mode, are avoided or not allowed for the transform skip mode. Note that the above example is for 8-bit video signals and need an adjustment depending on the input video signal bit-depth. An increase of a bit-depth by one results in a decrease of the threshold value by minus six. The signaling may be direct or indirect, such as via the specification of the difference of the internal bit-depth relative to the input bit-depth, the direct signalling of the input bit-depth, and/or the signalling of the threshold. An example for the indirect configuration is as follows.

sps_internal_bit_depth_minus_input_bit_depth specifies the minimum allowed quantization parameter for transform skip mode as follows:

QpPrimeTsMin=4+6*sps_internal_bit_depth_minus_input_bit_depth

The value of sps_internal_bit_depth_minus_input_bit_depth shall be in the range of 0 to 8, inclusive.
Otherwise (transform_skip_flag[xTbY][yTbY][cldx] is equal to 1), the following applies:

qP=Clip3(QpPrimeTsMin, 63+QpBdOffset, qP+QpActOffset)

According to an embodiment, the quantization of the block to be quantized, performed by the encoder, comprises a scaling followed by an integer quantization, e.g., a quantization to the nearest integer value. Similarly, the dequantization of the block to be dequantized, performed by the decoder, comprises a scaling, e.g., a rescaling, followed by an integer dequantization, e.g., a dequantization to the nearest integer value. Additionally, the encoder and/or the decoder is configured such that the predetermined threshold and/or the default quantization accuracy relate to a scaling factor, e.g. a rescaling factor in case of the decoder, of one. The encoder can be configured to use the scaling factor to quantize the block to be quantized and the decoder can be configured to use the scaling factor to dequantize the block to be dequantized. The encoder can be configured to quantize the block to be quantized by dividing values of the block to be quantized by the scaling factor and the decoder can be configured to dequantize the block to be dequantized by multiplying values of the block to be dequantized with the scaling factor. The encoder and/or decoder, for example, is configured to check whether the initial quantization accuracy is finer than the predetermined threshold by checking whether the scaling factor, e.g., a quantization step size Δ(QP), is smaller than a predetermined scaling factor. The predetermined scaling factor defines, for example, a scaling factor of one. The encoder and/or decoder can be configured to clip the scaling factor, to a minimum value of one, if the selected transform mode is the identity transform. The encoder and/or decoder can be configured to prohibit a scaling factor smaller than 1. If the Δ(QP) is smaller than one, the encoder is configured to set the Δ(QP) to one and if the Δ(QP) is one or greater, the Δ(QP) is maintained, e.g., resulting in a scaling factor of at least one, if the selected transform mode is an identity transform.

According to an embodiment, the encoder and/or decoder is configured to determine the initial quantization accuracy for several blocks, e.g., neighboring blocks, comprising the predetermined block, such as a whole picture, comprising the predetermined block, for several pictures, comprising the predetermined block, or for a slice of a picture, which comprises the predetermined block. In case of the several pictures, at least one or only one of the pictures has to comprise the predetermined block. In case of the encoder, the pictures are pictures of a picture signal or a video signal to be encoded and the several blocks are, e.g., blocks in a picture of the picture signal or the video signal. In case of the decoder, the blocks are, e.g., prediction residual blocks in a residual picture of a decoded picture signal or a decoded video signal.

The encoder can be configured to signal the initial quantization accuracy in the data stream, for example, for several blocks, such as a whole picture, for several pictures or for a slice of a picture. The decoder can be configured to read the initial quantization accuracy from the data stream, for example, for several blocks, such as a whole picture, for several pictures or for a slice of a picture.

According to an embodiment, the encoder is configured to signal the quantization accuracy and/or the selected transform mode in the data stream. The decoder, for example, is configured to read the quantization accuracy and/or the selected transform mode from the data stream.

According to an embodiment, the predetermined block represents a block of a prediction residual of the picture signal to be block-based encoded, in case of the encoder. In case of the decoder, the predetermined block, for example, represents a block of a prediction residual of the picture signal to be block-based decoded. The predetermined block, for example, represents a decoded residual block in case of the decoder.

According to an embodiment, the encoder and/or decoder is configured to determine an initial quantization accuracy, for the predetermined block and modify the initial quantization accuracy, dependent on the selected transform mode. The initial quantization accuracy, e.g., comprises the index, i.e. the QP, and/or the scaling factor, i.e., the Δ(QP). Thus it is possible to increase the compression efficiency. This is based on the idea, that the initial quantization accuracy can be signaled in the data stream for a group of blocks or for several pictures and that for each block to be encoded or decoded it is possible to adapt this initial quantization accuracy individually dependent on the transform mode for the respective block.

The modifying of the initial quantization accuracy can be performed by offsetting the initial quantization accuracy using an offset value, dependent on the selected transform mode. The offset may be chosen such that the compression efficiency is increased, e.g., by maximizing a perceived visual quality or minimizing objective distortion like a square error for a given bitrate, or by reducing the bitrate for a given quality/distortion. According to an embodiment, the encoder and/or the decoder is configured to determine the offset value for each transform mode. This can be performed for each picture signal or video signal individually. Alternatively, the offset value is determined for smaller entities such as several pictures, one picture, one or more slices of a picture, groups of blocks or individual blocks. Alternatively or additionally, for each transform mode the offset value can be obtained from a list of offset values.

As aforementioned, the encoder may be configured to determine the initial quantization accuracy by determining an index out of a quantization parameter list. Similarly, the decoder may be configured to determine the initial quantization accuracy by determining an index out of a dequantization parameter list. According to an embodiment, the encoder and/or decoder is configured to modify the initial quantization accuracy by adding the offset value to the index or by subtracting the offset value from the index. The index, i.e. the quantization parameter (QP), for example, is decreased or increased by the offset value.

As aforementioned, in case of the encoder, the quantization of the block to be quantized may comprise a scaling followed by an integer quantization, e.g., a quantization to the nearest integer value. The encoder can be configured to perform the scaling by dividing values of the block to be quantized by a scaling factor. Similarly, in case of the decoder, the dequantization of the block to be dequantized may comprise a scaling, e.g., a rescaling, followed by an integer dequantization, e.g. a dequantization to the nearest integer value and the decoder can be configured to perform the scaling by multiplying values of the block to be dequantized with the scaling factor, e.g., a rescaling factor. Additionally, the encoder and/or decoder may be configured to modify the initial quantization accuracy by adding the offset value to the scaling factor or by subtracting the offset value from the scaling factor. The scaling factor, for example, equals the quantization step size Δ(QP). The quantization step size Δ(QP) can be decreased or increased by the offset value.

According to an embodiment, the encoder and/or the decoder is configured to provide the modified initial quantization accuracy dependent on whether the selected transform mode is an identity transform or a non-identity transform. In other words, the encoder and/or the decoder may be configured to modify the initial quantization accuracy dependent on whether the selected transform mode is an identity transform or a non-identity transform.

According to an embodiment, the encoder and/or decoder is configured to, if the selected transform mode is the identity transform, determine an initial quantization accuracy for the predetermined block and check whether the initial quantization accuracy is coarser than a predetermined threshold, and additionally if the initial quantization accuracy is coarser than the predetermined threshold, the encoder and/or decoder is configured to modify the initial quantization accuracy using an offset value, dependent on the selected transform mode, such that a modified initial quantization accuracy is finer than the predetermined threshold. The initial quantization accuracy, for example, is coarser than the predetermined threshold, if the index (QP) is greater than 10, 20, 30, 35, 40 or 45. In other words, the predetermined threshold can be represented by an index of 10, 20, 30, 35, 40 or 45. Thus the index or the scaling factor is decreased by the offset value at a second end of a bit-rate range, i.e. for low bit rates. The second end of the bit-rate range is, for example, associated with an end of the bit rate range opposite to a first end of the bit rate range, associated with QP's of four or lower.

According to an embodiment, the encoder and/or the decoder is configured to, if the initial quantization accuracy is not coarser than the predetermined threshold, not modify the initial quantization accuracy using the offset value, dependent on the selected transform mode.

According to an embodiment, the encoder and/or the decoder is configured to, if the selected transform mode is a non-identity transform, not modify the initial quantization accuracy using the offset value. Thus the offset, for example, is only used in case of the transform mode being the identity transform.

According to an embodiment, the encoder and/or the decoder is configured to determine the offset by using a rate-distortion optimization. Thus a high compression efficiency resulting only in small or no distortions can be achieved dependent on the transform mode to be used for the predetermined block, for which the offset is determined.

According to an embodiment, the encoder is configured to signal the offset, e.g. the offset value or an index pointing to the offset value in a set of offset values, in the data stream for several blocks, e.g. neighboring blocks, comprising the predetermined block, such as a whole picture, comprising the predetermined block, for several pictures, comprising the predetermined block, or for a slice of a picture, which comprises the predetermined block. The pictures, e.g., are pictures of a picture signal or a video signal to be encoded and the several blocks are, e.g., blocks in a picture of the picture signal or the video signal.

According to an embodiment, the decoder is configured to read the offset, e.g. the offset value or an index pointing to the offset value in a set of offset values, out of the data stream for several blocks, comprising the predetermined block, such as a whole picture, comprising the predetermined block, for several pictures, comprising the predetermined block, or for a slice of a picture, which comprises the predetermined block. configured to read the offset out of the data stream for several blocks, comprising the predetermined block, such as a whole picture, comprising the predetermined block, for several pictures, comprising the predetermined block, or for a slice of a picture, which comprises the predetermined block.

In case of the encoder, the quantization of the block to be quantized comprises optionally a block-global scaling, e.g. one scaling factor for all values of the block, and a scaling with an intra-block-varying scaling matrix followed by an integer quantization, e.g. a quantization to the nearest integer value. The intra-block-varying scaling matrix, e.g., is a matrix with a plurality of scaling factors, like e.g. a plurality of quantization parameters (QP) or a plurality of quantization step sizes Δ(QP). Each transform coefficient, e.g., obtained by the encoder before the scaling, by applying the selected transform to the predetermined block, is scaled by one of the plurality of scaling factors of the scaling matrix. The scaling with the intra-block-varying scaling matrix can result in a frequency-dependent weighting or a spatially-dependent weighting. Additionally, the encoder may be configured to determine the intra-block-varying scaling matrix dependent on the selected transform mode.

In case of the decoder, the dequantization of the block to be dequantized comprises a block-global scaling, i.e. a block-global rescaling, e.g. one scaling factor, i.e. a rescaling factor, for all values of the block, and a scaling, e.g. a rescaling, with an intra-block-varying scaling matrix, i.e. an intra-block-varying rescaling matrix, followed by an integer dequantization, e.g. a dequantization to the nearest integer value. The intra-block-varying scaling matrix, e.g., is a matrix with a plurality of scaling factors, i.e. rescaling factors, like, e.g., a matrix with a plurality of quantization parameters (QP) or a plurality of quantization step sizes Δ(QP). Each value of the block, e.g., is scaled by one of the plurality of scaling factors of the scaling matrix individually. The scaling by the intra-block-varying scaling matrix, e.g., results in a frequency-dependent weighting or a spatially-dependent weighting. Additionally, the decoder may be configured to determine the intra-block-varying scaling matrix dependent on the selected transform mode.

According to an embodiment, the encoder and/or the decoder is configured to determine the intra-block-varying scaling matrix so that the determination results in different intra-block-varying scaling matrices for different blocks to be quantized or to be dequantized, which are equal in size and shape. Thus a first intra-block-varying scaling matrix for a first block and a second intra-block-varying scaling matrix for second block can differ, wherein the first block and the second block can have the same size and shape.

Additionally, the determination is optionally such that the intra-block-varying scaling matrix determined for the different blocks to be quantized or for the different blocks to be dequantized, which different blocks are equal in size and shape, depends on the selected transform mode and the selected transform mode is unequal to an identity transform. This is based on the idea, that in case of the selected transform mode being the identity transform, a frequency-weighted scaling is not beneficial. For the identity transform, for example, the block-global scaling or a spatial-weighted scaling matrix can be used. However, for the transform mode being equal to a non-identity transform, it is beneficial to scale every transform coefficient of the block to be quantized or to be dequantized, individually. The intra-block-varying scaling matrix can differ for different non-identity transform modes.

According to an embodiment, the encoder is configured to, if the selected transform mode is a non-identity transform, apply a transform corresponding to the selected transform mode to the predetermined block to obtain the block to be quantized and if the selected transform mode is an identity transform, the predetermined block is the block to be quantized.

According to an embodiment, the decoder is configured to, if the selected transform mode is a non-identity transform, apply a reverse transform corresponding to the selected transform mode to the dequantized block to obtain the predetermined block and if the selected transform mode is an identity transform, the dequantized block is the predetermined block.

An embodiment is related to a method for block-based encoding of a picture signal using transform coding, comprising selecting for a predetermined block, e.g., a block in an area of blocks in a video signal or a picture signal, a selected transform mode, e.g., an identity transform or a non-identity transform. The identity transform, for example, is understood as a transform skip. Additionally the method comprises quantizing a block to be quantized, which is associated with the predetermined block according to the selected transform mode, using a quantization accuracy, which depends on the selected transform mode, to obtain a quantized block. The block to be quantized, e.g., is the predetermined block subjected to the selected transform mode and/or a block obtained by applying a transform underlying the selected transform mode onto the predetermined block, in case of the selected transform mode being a non-identity transform, and equalizing the predetermined block, in case of the selected transform mode being an identity transform.

The quantization accuracy, e.g., is defined by a quantization parameter (QP), a scaling factor and/or a quantization step size. Values of the block, for example, are divided by the quantization parameter (QP), the scaling factor and/or the quantization step size to receive the quantized block. Furthermore, the method comprises entropy encoding the quantized block into a data stream.

An embodiment is related to a method for block-based decoding of an encoded picture signal using transform decoding, comprising selecting for a predetermined block, e.g., a residual block in an area of neighboring residual blocks in a decoded residual picture signal or residual video signal, a selected transform mode, e.g., an identity transform or a non-identity transform. The identity transform, for example, is understood as a transform skip and the non-identity transform, for example, is an inverse/reverse transformation of the transformation applied by an encoder. Additionally, the method comprises entropy decoding a block to be dequantized, which is associated with the predetermined block according to the selected transform mode, from a data stream and dequantizing the block to be dequantized using a quantization accuracy, which depends on the selected transform mode, to obtain a dequantized block. The quantization accuracy, e.g., is defined by a quantization parameter (QP), a scaling factor and/or a quantization step size. Values of the block may be multiplied with the quantization parameter (QP), the scaling factor and/or the quantization step size to receive the dequantized block. The quantization accuracy, for example, defines an accuracy of the dequantization of the block to be dequantized.

The methods as described above are based on the same considerations as the above-described encoder and/or decoder. The methods can, by the way, be completed with all features and functionalities, which are also described with regard to the encoder and/or decoder.

An embodiment is related to a computer program having a program code for performing, when running on a computer, a herein described method.

An embodiment is related to a data stream obtained by a method for block-based encoding of a picture signal.

### BRIEF DESCRIPTION OF THE DRAWINGS

Embodiments of the present invention will be detailed subsequently referring to the appended drawings, in which:

FIG. 1a shows a schematic view of an encoder;

FIG. 1b shows a schematic view of an alternative encoder;

FIG. 2 shows a schematic view of a decoder;

FIG. 3 shows a schematic view of a block-based coding;

FIG. 4 shows a schematic view of an encoder according to an embodiment;

FIG. 5 shows a schematic view of a decoder according to an embodiment;

FIG. 6 shows a schematic view of a decoder-side scaling and inverse transform in recent video coding standards;

FIG. 7 shows a schematic view of a decoder-side scaling and inverse transform according to an embodiment;

FIG. 8 shows a block diagram of a method for block-based encoding according to an embodiment; and

FIG. 9 shows a block diagram of a method for block-based decoding according to an embodiment.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

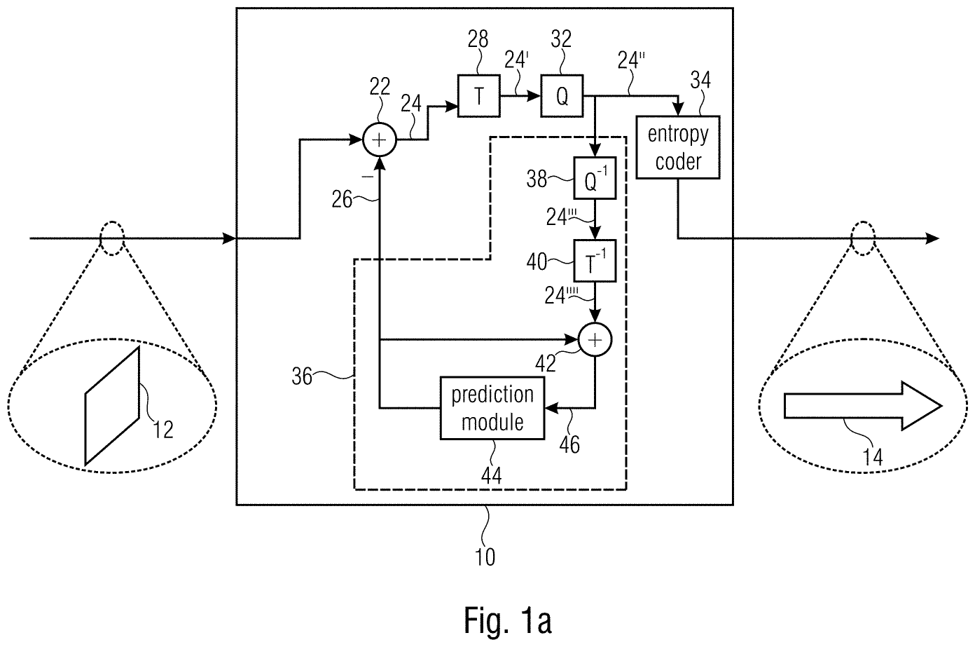

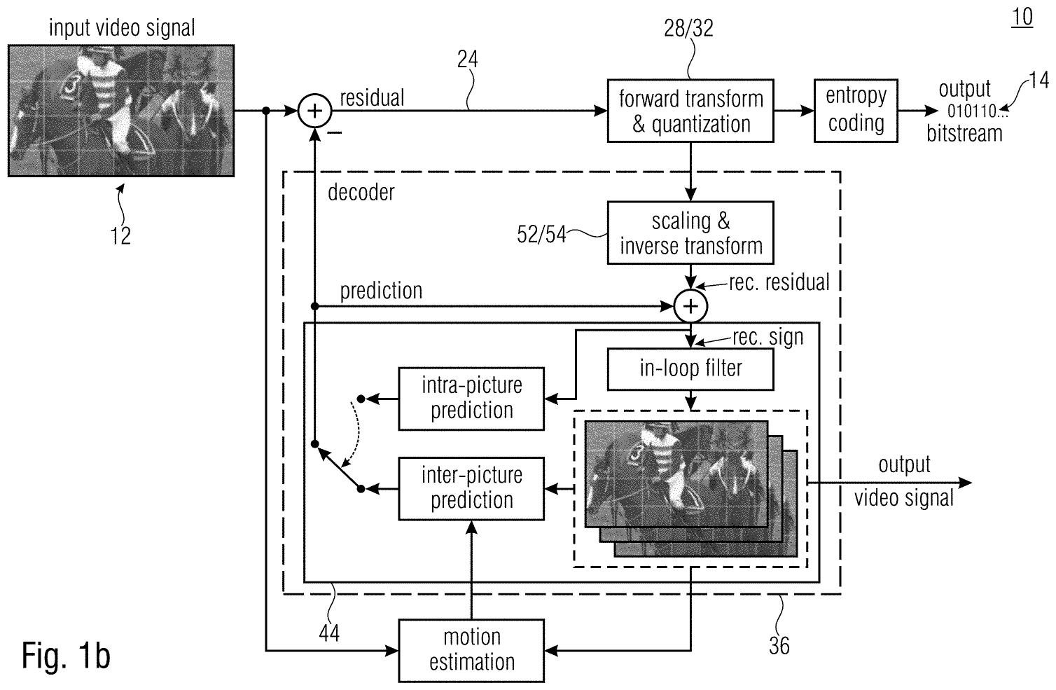

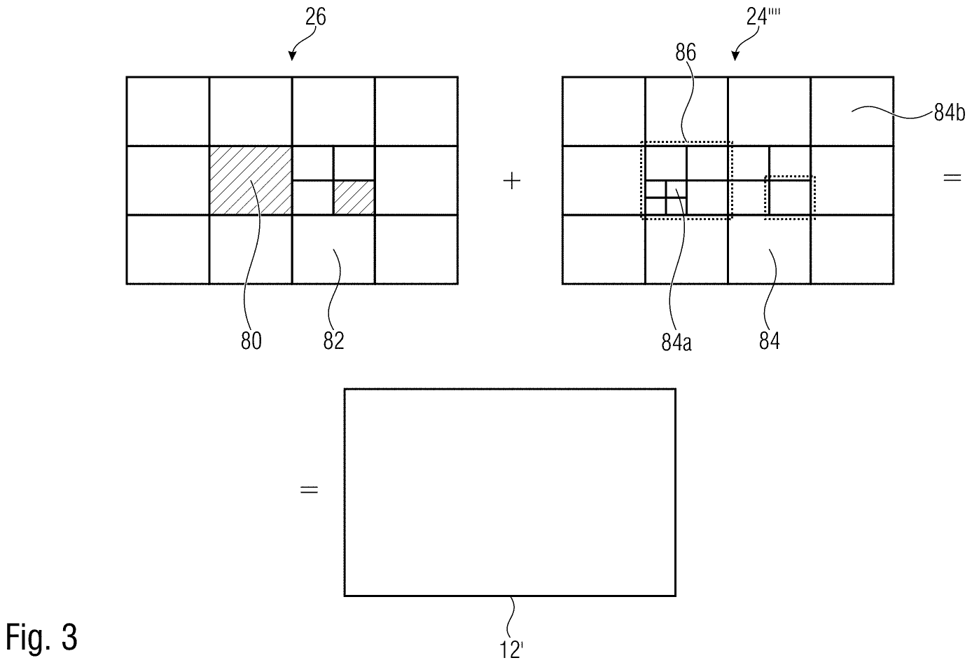

The following description of the figures starts with a presentation of a description of an encoder and a decoder of a block-based predictive codec for coding pictures of a video in order to form an example for a coding framework into which embodiments of the present invention may be built in. The respective encoder and decoder are described with respect to FIGS. 1a to 3. The herein described embodiments of the concept of the present invention could be built into the encoder and decoder of FIGS. 1a, 1b and 2, respectively, although the embodiments described with the FIGS. 4 to 7, may also be used to form encoders and decoders not operating according to the coding framework underlying the encoder and decoder of FIGS. 1a, 1b and 2.

FIG. 1a shows an apparatus (e. g. a video encoder and/or a picture encoder) for predictively coding a picture 12 into a data stream 14 exemplarily using transform-based residual coding. The apparatus, or encoder, is indicated using reference sign 10. FIG. 1b shows also the apparatus for predictively coding a picture 12 into a data stream 14, wherein a possible prediction module 44 is shown in more detail. FIG. 2 shows a corresponding decoder 20, i.e. an apparatus 20 configured to predictively decode the picture 12′ from the data stream 14 also using transform-based residual decoding, wherein the apostrophe has been used to indicate that the picture 12′ as reconstructed by the decoder 20 deviates from picture 12 originally encoded by apparatus 10 in terms of coding loss introduced by a quantization of the prediction residual signal. FIG. 1a, 1b and FIG. 2 exemplarily use transform based prediction residual coding, although embodiments of the present application are not restricted to this kind of prediction residual coding. This is true for other details described with respect to FIGS. 1a, 1b and 2, too, as will be outlined hereinafter.

The encoder 10 is configured to subject the prediction residual signal to spatial-to-spectral transformation and to encode the prediction residual signal, thus obtained, into the data stream 14. Likewise, the decoder 20 is configured to decode the prediction residual signal from the data stream 14 and subject the prediction residual signal, thus obtained, to spectral-to-spatial transformation.

Internally, the encoder 10 may comprise a prediction residual signal former 22 which generates a prediction residual 24 so as to measure a deviation of a prediction signal 26 from the original signal, i.e. from the picture 12, wherein the prediction signal 26 can be interpreted as a linear combination of a set of one or more predictor blocks according to an embodiment of the present invention. The prediction residual signal former 22 may, for instance, be a subtractor which subtracts the prediction signal from the original signal, i.e. from the picture 12. The encoder 10 then further comprises a transformer 28 which subjects the prediction residual signal 24 to a spatial-to-spectral transformation to obtain a spectral-domain prediction residual signal 24′ which is then subject to quantization by a quantizer 32, also comprised by the encoder 10. The thus quantized prediction residual signal 24″ is coded into bitstream 14. To this end, encoder 10 may optionally comprise an entropy coder 34 which entropy codes the prediction residual signal as transformed and quantized into data stream 14.

The prediction signal 26 is generated by a prediction stage 36 of encoder 10 on the basis of the prediction residual signal 24″ encoded into, and decodable from, data stream 14. To this end, the prediction stage 36 may internally, as is shown in FIG. 1a, comprise a dequantizer 38 which dequantizes prediction residual signal 24″ so as to gain spectral-domain prediction residual signal 24′″, which corresponds to signal 24′ except for quantization loss, followed by an inverse transformer 40 which subjects the latter prediction residual signal 24′″ to an inverse transformation, i.e. a spectral-to-spatial transformation, to obtain prediction residual signal 24′″, which corresponds to the original prediction residual signal 24 except for quantization loss. A combiner 42 of the prediction stage 36 then recombines, such as by addition, the prediction signal 26 and the prediction residual signal 24′″ so as to obtain a reconstructed signal 46, i.e. a reconstruction of the original signal 12. Reconstructed signal 46 may correspond to signal 12′. A prediction module 44 of prediction stage 36 then generates the prediction signal 26 on the basis of signal 46 by using, for instance, spatial prediction, i.e. intra-picture prediction, and/or temporal prediction, i.e. inter-picture prediction, as shown in FIG. 1b in more detail.

Likewise, decoder 20, as shown in FIG. 2, may be internally composed of components corresponding to, and interconnected in a manner corresponding to, prediction stage 36. In particular, entropy decoder 50 of decoder 20 may entropy decode the quantized spectral-domain prediction residual signal 24″ from the data stream, whereupon dequantizer 52, inverse transformer 54, combiner 56 and prediction module 58, interconnected and cooperating in the manner described above with respect to the modules of prediction stage 36, recover the reconstructed signal on the basis of prediction residual signal 24″ so that, as shown in FIG. 2, the output of combiner 56 results in the reconstructed signal, namely picture 12′.

Although not specifically described above, it is readily clear that the encoder 10 may set some coding parameters including, for instance, prediction modes, motion parameters and the like, according to some optimization scheme such as, for instance, in a manner optimizing some rate and distortion related criterion, i.e. coding cost. For example, encoder 10 and decoder 20 and the corresponding modules 44, 58, respectively, may support different prediction modes such as intra-coding modes and inter-coding modes. The granularity at which encoder and decoder switch between these prediction mode types may correspond to a subdivision of picture 12 and 12′, respectively, into coding segments or coding blocks. In units of these coding segments, for instance, the picture may be subdivided into blocks being intra-coded and blocks being inter-coded.

Intra-coded blocks are predicted on the basis of a spatial, already coded/decoded neighborhood (e. g. a current template) of the respective block (e. g. a current block) as is outlined in more detail below. Several intra-coding modes may exist and be selected for a respective intra-coded segment including directional or angular intra-coding modes according to which the respective segment is filled by extrapolating the sample values of the neighborhood along a certain direction which is specific for the respective directional intra-coding mode, into the respective intra-coded segment. The intra-coding modes may, for instance, also comprise one or more further modes such as a DC coding mode, according to which the prediction for the respective intra-coded block assigns a DC value to all samples within the respective intra-coded segment, and/or a planar intra-coding mode according to which the prediction of the respective block is approximated or determined to be a spatial distribution of sample values described by a two-dimensional linear function over the sample positions of the respective intra-coded block with driving tilt and offset of the plane defined by the two-dimensional linear function on the basis of the neighboring samples.

Compared thereto, inter-coded blocks may be predicted, for instance, temporally. For inter-coded blocks, motion vectors may be signaled within the data stream 14, the motion vectors indicating the spatial displacement of the portion of a previously coded picture (e. g. a reference picture) of the video to which picture 12 belongs, at which the previously coded/decoded picture is sampled in order to obtain the prediction signal for the respective inter-coded block. This means, in addition to the residual signal coding comprised by data stream 14, such as the entropy-coded transform coefficient levels representing the quantized spectral-domain prediction residual signal 24″, data stream 14 may have encoded thereinto coding mode parameters for assigning the coding modes to the various blocks, prediction parameters for some of the blocks, such as motion parameters for inter-coded segments, and optional further parameters such as parameters for controlling and signaling the subdivision of picture 12 and 12′, respectively, into the segments. The decoder 20 uses these parameters to subdivide the picture in the same manner as the encoder did, to assign the same prediction modes to the segments, and to perform the same prediction to result in the same prediction signal.

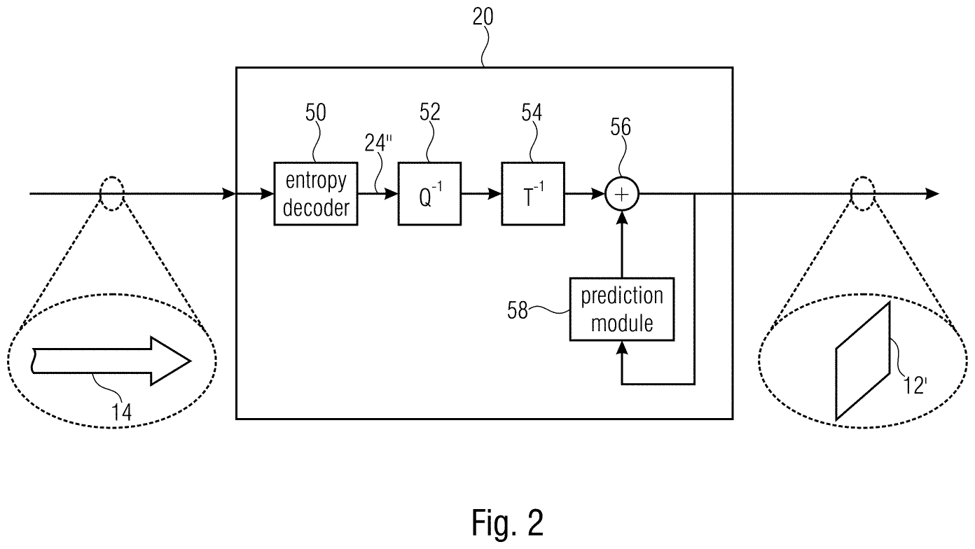

FIG. 3 illustrates the relationship between the reconstructed signal, i.e. the reconstructed picture 12′, on the one hand, and the combination of the prediction residual signal 24″″ as signaled in the data stream 14, and the prediction signal 26, on the other hand. As already denoted above, the combination may be an addition. The prediction signal 26 is illustrated in FIG. 3 as a subdivision of the picture area into intra-coded blocks which are illustratively indicated using hatching, and inter-coded blocks which are illustratively indicated not-hatched. The subdivision may be any subdivision, such as a regular subdivision of the picture area into rows and columns of square blocks or non-square blocks, or a multi-tree subdivision of picture 12 from a tree root block into a plurality of leaf blocks of varying size, such as a quadtree subdivision or the like, wherein a mixture thereof is illustrated in FIG. 3 in which the picture area is first subdivided into rows and columns of tree root blocks which are then further subdivided in accordance with a recursive multi-tree subdivisioning into one or more leaf blocks.

Again, data stream 14 may have an intra-coding mode coded thereinto for intra-coded blocks 80, which assigns one of several supported intra-coding modes to the respective intra-coded block 80. For inter-coded blocks 82, the data stream 14 may have one or more motion parameters coded thereinto. Generally speaking, inter-coded blocks 82 are not restricted to being temporally coded. Alternatively, inter-coded blocks 82 may be any block predicted from previously coded portions beyond the current picture 12 itself, such as previously coded pictures of a video to which picture 12 belongs, or picture of another view or an hierarchically lower layer in the case of encoder and decoder being scalable encoders and decoders, respectively.

The prediction residual signal 24″″ in FIG. 3 is also illustrated as a subdivision of the picture area into blocks 84. These blocks might be called transform blocks in order to distinguish same from the coding blocks 80 and 82. In effect, FIG. 3 illustrates that encoder 10 and decoder 20 may use two different subdivisions of picture 12 and picture 12′, respectively, into blocks, namely one subdivisioning into coding blocks 80 and 82, respectively, and another subdivision into transform blocks 84. Both subdivisions might be the same, i.e. each coding block 80 and 82, may concurrently form a transform block 84, but FIG. 3 illustrates the case where, for instance, a subdivision into transform blocks 84 forms an extension of the subdivision into coding blocks 80, 82 so that any border between two blocks of blocks 80 and 82 overlays a border between two blocks 84, or alternatively speaking each block 80, 82 either coincides with one of the transform blocks 84 or coincides with a cluster of transform blocks 84. However, the subdivisions may also be determined or selected independent from each other so that transform blocks 84 could alternatively cross block borders between blocks 80, 82. As far as the subdivision into transform blocks 84 is concerned, similar statements are thus true as those brought forward with respect to the subdivision into blocks 80, 82, i.e. the blocks 84 may be the result of a regular subdivision of picture area into blocks (with or without arrangement into rows and columns), the result of a recursive multi-tree subdivisioning of the picture area, or a combination thereof or any other sort of blockation. Just as an aside, it is noted that blocks 80, 82 and 84 are not restricted to being of quadratic, rectangular or any other shape.

FIG. 3 further illustrates that the combination of the prediction signal 26 and the prediction residual signal 24″″ directly results in the reconstructed signal 12′. However, it should be noted that more than one prediction signal 26 may be combined with the prediction residual signal 24″″ to result into picture 12′ in accordance with alternative embodiments.

In FIG. 3, the transform blocks 84 shall have the following significance. Transformer 28 and inverse transformer 54 perform their transformations in units of these transform blocks 84. For instance, many codecs use some sort of DST (discrete sine transform) or DCT (discrete cosine transform) for all transform blocks 84. Some codecs allow for skipping the transformation so that, for some of the transform blocks 84, the prediction residual signal is coded in the spatial domain directly. However, in accordance with embodiments described below, encoder 10 and decoder 20 are configured in such a manner that they support several transforms. For example, the transforms supported by encoder 10 and decoder 20 could comprise:
DCT-II (or DCT-III), where DCT stands for Discrete Cosine Transform
DST-IV, where DST stands for Discrete Sine Transform
DCT-IV
DST-VII
Identity Transformation (IT)

Naturally, while transformer 28 would support all of the forward transform versions of these transforms, the decoder 20 or inverse transformer 54 would support the corresponding backward or inverse versions thereof:
Inverse DCT-II (or inverse DCT-III)
Inverse DST-IV
Inverse DCT-IV
Inverse DST-VII
Identity Transformation (IT)

The subsequent description provides more details on which transforms could be supported by encoder 10 and decoder 20. In any case, it should be noted that the set of supported transforms may comprise merely one transform such as one spectral-to-spatial or spatial-to-spectral transform, but it is also possible, that no transform is used by the encoder or decoder at all or for single blocks 80, 82, 84.

As already outlined above, FIGS. 1a to 2 have been presented as an example where the inventive concept described herein may be implemented in order to form specific examples for encoders and decoders according to the present application. Insofar, the encoder and decoder of FIGS. 1a, 1b and 2, respectively, may represent possible implementations of the encoders and decoders described herein before. FIGS. 1a, 1b and 2 are, however, only examples. An encoder according to embodiments of the present application may, however, perform block-based encoding of a picture 12 using the concept outlined in more detail before or hereinafter and being different from the encoder of FIG. 1a or 1b such as, for instance, in that the sub-division into blocks 80 is performed in a manner different than exemplified in FIG. 3 and/or in that no transform (e.g. transform skip/identity transform) is used at all or for single blocks. Likewise, decoders according to embodiments of the present application may perform block-based decoding of picture 12′ from data stream 14 using a coding concept further outlined below, but may differ, for instance, from the decoder 20 of FIG. 2 in that same sub-divides picture 12′ into blocks in a manner different than described with respect to FIG. 3 and/or in that same does not derive the prediction residual from the data stream 14 in transform domain, but in spatial domain, for instance and/or in that same does not use any transform at all or for single blocks.

According to an embodiment the inventive concept described before can be implemented in the quantizer 32 of the encoder or in the dequantizer 38, 52 of the decoder. According to an embodiment thus the quantizer 32 and/or the dequantizer 38, 52 can be configured to apply different scalings to a block to be quantized dependent on a selected transform applied by the transformer 28 or to be applied by the inverse transformer 54. Thus the quantizer 32 and/or the dequantizer 38, 52 is configured to not only use one predefined scaling for all transform modes (i.e. transform types) but also to use for each selected transform mode a different scaling.

State-of-the-art hybrid video coding technologies employ the same scaling factor for inverse quantization independent from the employed transform and block size. The presented invention describes methods that allow the usage of different scaling factors depending on the selected transform and block size. From encoder point-of-view, the quantization step size differs depending on the selected transform and transform block size. By combining different quantization step sizes depending on transform type and transform block size, an encoder can achieve higher compression efficiency.

FIG. 4 shows an encoder 10 for block-based encoding of a picture signal using transform coding. A predetermined block 18 of a prediction residual 24 of an input picture 12 is executed by the encoder 10.

The encoder 10 is configured to select for the predetermined block 18 a selected transform mode 130. The selected transform mode 130, for example, is selected based on a content of the predetermined block 18 or based on a content of the prediction residual 24 of the input picture 12 or based on a content of the input picture 12. The encoder can choose the selected transform mode 130 out of transform modes 128, which can be divided into non-identity transformations 1281 and an identity transformation 1282.

According to an embodiment, the non-identity transformations 1281 comprise a DCT-II, DCT-III, DCT-IV, DST-IV and/or DST-VII transformation.

Additionally, the encoder 10 is configured to quantize a block 18′ to be quantized, which is associated with the predetermined block 18 according to the selected transform mode 130, using a quantization accuracy 140, which depends on the selected transform mode 130, to obtain a quantized block 18″.

According to an embodiment, the block 18′ to be quantized by a quantizer 32 can be obtained by the encoder by one or more processing steps applied to the predetermined block 18, wherein the encoder 10 can be configured to use the selected transform mode 130 in one of the steps. The block 18′ to be quantized is, for example, a processed version of the predetermined block 18. The block 18′ to be quantized, for example, is obtained by an application of the selected transform mode 130 on the predetermined block 18, wherein the identity transformation can correspond to a transform skip.

The block 18′ to be quantized is quantized with a certain quantization accuracy 140. The quantization accuracy 140 can be determined based on the selected transform mode 130 selected for the predetermined block 18, which predetermined block 18 is associated with the block 18′ to be quantized. With an optimized quantization accuracy 140 distortions resulting from the quantization can be reduced. The same quantization accuracy can result in a different amount of distortions for different transform modes 128. Thus it is advantageous to associate individual quantization accuracy's 140 with different transform modes 128.

The encoder 10, for example, is configured to determine quantization parameters for the block 18′ to be quantized defining the quantization accuracy 140. The quantization accuracy 140, for example, is defined by a quantization parameter (QP), a scaling factor and/or a quantization step size.

The quantized block 18″ resulting from the quantization of the block 18′ with the individual quantization accuracy 140 is entropy encoded into a data stream 14 by an entropy encoder 34 of the encoder 10.

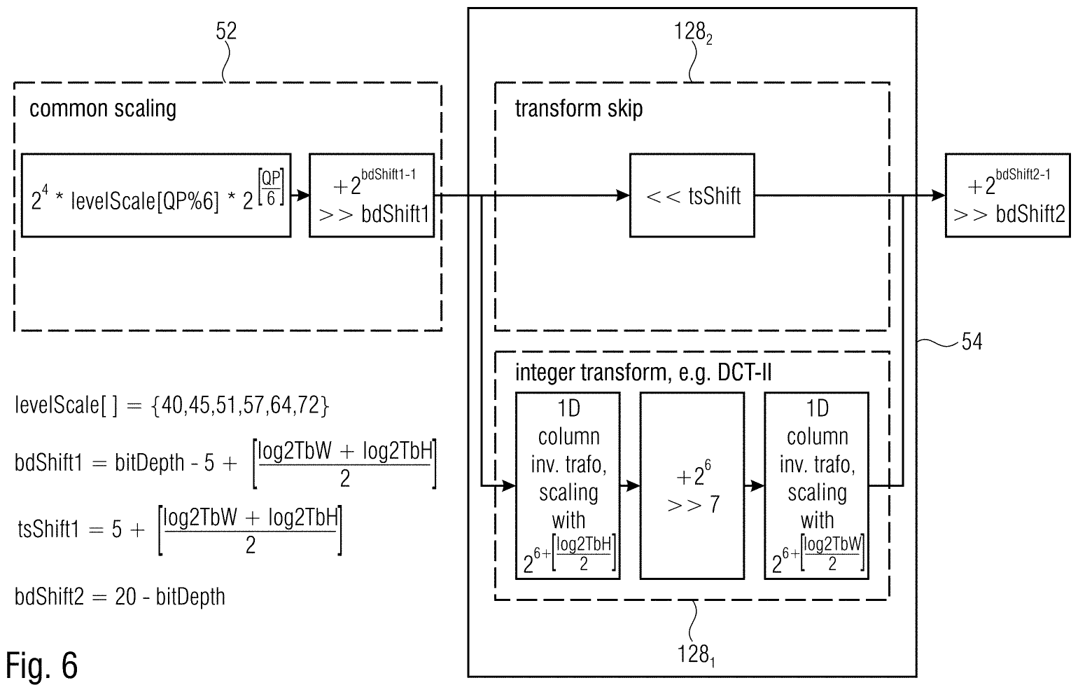

Optionally, the encoder 10 can comprise additional features similarly or as described with regard to FIG. 7.

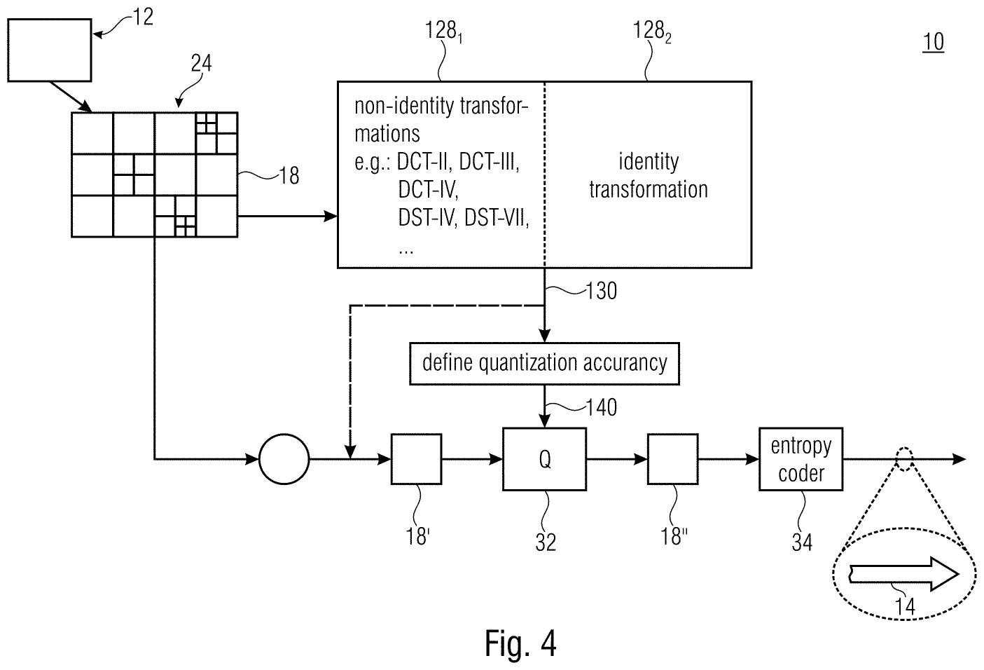

FIG. 5 shows a decoder 20 for block-based decoding of an encoded picture signal using transform decoding. The decoder 20 may be configured to reconstruct an output picture from a data stream 14, wherein a predetermined block 118 can represent a block of a prediction residual of the output picture.

The decoder 20 is configured to select for the predetermined block 118 a selected transform mode 130. The selected transform mode 130, for example, is selected based on a signaling in the data stream 14. The decoder can choose the selected transform mode 130 out of transform modes 128, which can be divided into non-identity transformations 1281 and an identity transformation 1282.

The non-identity transformations 1281 can represent inverse/reverse transformations of the transformations applied by an encoder. According to an embodiment, the non-identity transformations 1281 comprise an inverse DCT-II, inverse DCT-III, inverse DCT-IV, inverse DST-IV and/or inverse DST-VII transformation.

Additionally, the decoder 20 is configured to entropy decode by an entropy decoder 50 a block 118′ to be dequantized, which is associated with the predetermined block 118 according to the selected transform mode 130, from the data stream 14. According to an embodiment, the block 118′ to be dequantized can be processed by one or more steps performed by the decoder 20 resulting in the predetermined block 118, wherein the decoder 20 can be configured to use the selected transform mode 130 in one of the steps. The predetermined block 118 is, for example, a processed version of the block 118′ to be dequantized. The block 118′ to be quantized, for example, is the predetermined block 118 before subjected to the selected transform mode 130. As shown in FIG. 5, optionally the decoder 20 is configured to use an inverse transformer 54 to obtain the predetermined block 118 using the selected transform mode 130.

Additionally, the decoder 20 is configured to dequantize the block 118′ to be dequantized by a dequantizer 52 using a quantization accuracy 140, which depends on the selected transform mode 130, to obtain a dequantized block 118″.

The block 118′ to be dequantized is dequantized with a certain quantization accuracy 140. The quantization accuracy 140 can be determined based on the selected transform mode 130 selected for the predetermined block 118, which predetermined block 118 is associated with the block 118′ to be dequantized. With an optimized quantization accuracy 140 distortions resulting from the quantization can be reduced. The same quantization accuracy can result in a different amount of distortions for different transform modes 128. Thus it is advantageous to associate individual quantization accuracy's 140 with different transform modes 128.

The decoder 20, for example, is configured to determine quantization parameters, i.e. dequantization parameters, for the block 118′ to be dequantized defining the quantization accuracy 140. The quantization accuracy 140, for example, is defined by a quantization parameter (QP), a scaling factor and/or a quantization step size.

The optional transformer 54 can be configured to transform the dequantized block 118″ using the selected transform mode 130 to obtain the predetermined block 118.

The present invention enables the possibility to vary the quantization step size, i.e. the quantization accuracy, depending on the selected transform and transform block size.

The following description is written from the decoder perspective and the decoder-side scaling 52 (multiplication) with the quantization step size can be seen as being the inverse (non-reversible) of the encoder-side division by the step size.

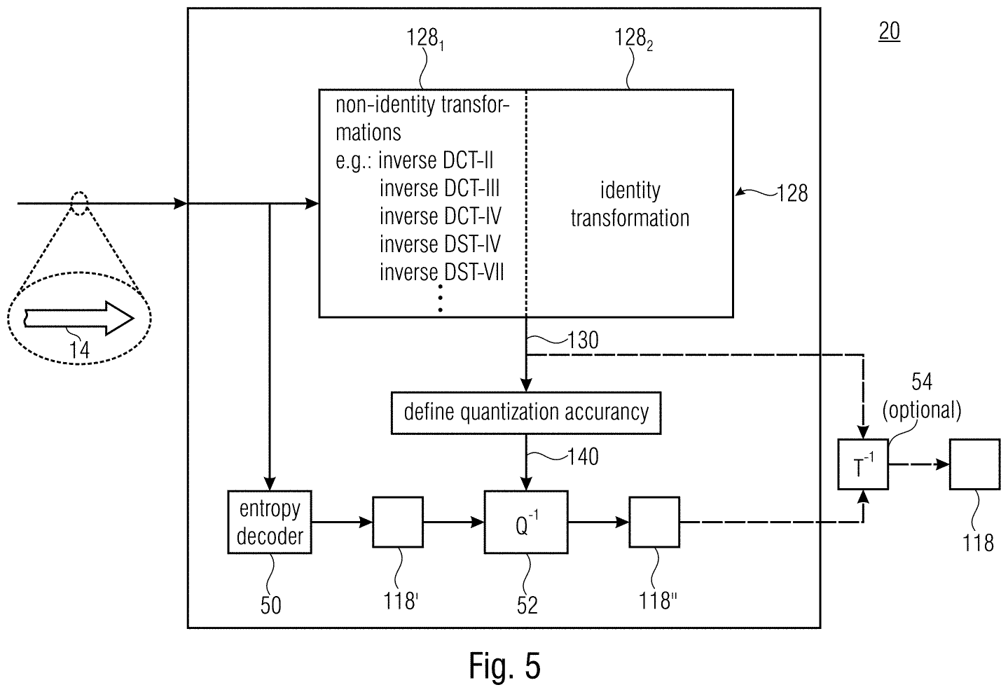

On the decoder side, the scaling 52, i.e. the dequantization, of (quantized) transform coefficient levels in current video coding standards like H.265/HEVC is designed for transform coefficients resulting from DCT/DST integer transforms with higher precision as illustrated in FIG. 6. In there, the variable bitDepth specifies the bit depth of the image samples, e.g. 8 or 10-bit. The variables log 2TbW and log 2TbH specify the binary logarithm of the transform block width and height, respectively. FIG. 6 shows a decoder-side scaling 52 and inverse transform 54 in recent video coding standards such as H.265/HEVC.

It should be noted that, at the decoder, the two 1D DCT/DST-based integer transforms 128₁ introduce an additional factor of 2¹²·\sqrt{2^{log2TbW+log 2TbH}}, which needs to be compensated by scaling with the inverse. For non-square blocks with an odd log 2TbH+log 2TbW, the scaling includes a factor of \sqrt{2}. This can be taken into account by either adding a scale factor of 181/256 or using a different set of levelScale values that incorporate that factor for this case, e.g. levelScalell={29, 32, 36, 40, 45, 51}. For the identity transform or transform skip case 1282, this does not apply.

It can be seen that the step size or scaling factor

$$( \frac{{2}^{4} \cdot l evelScal e [ Q P \% 6 ] \cdot 2 ⌊ \frac{Q P}{6} ⌋}{{2}^{10}} )$$

becomes smaller then 1 for QPs less than 4 because levelScale for these QPs is less than 64=2⁶. For the transform coefficients, this is not a problem since the integer forward transform 1281 increases the precision of the residual signal and consequently the dynamic range. However, for the residual signal in case of the identity transform or transform skip 1282, there is no increase in dynamic range. In this case, the scaling factor less than 1 could introduce a distortion for the QPs<4 which is not there for QP 4, which has a scaling factor of 1. This is contradictory to the quantizer design intent where decreasing the QP should decrease the distortion.

Varying the quantization step size depending on the selected transform, e.g. whether the transform is skipped or not, could be used to derive a different quantization step size for transform skip 1282. Especially for the lowest QPs 0,1,2 and 3, this would solve the problem of having a quantization step size/scaling factor less than 1 for the lowest QPs. In one embodiment shown in FIG. 7, the solution could be to clip 53 the quantization parameter to the minimum allowed value of four (QP), resulting in a quantization step size that cannot be lower than one. In addition to that, the size-dependent normalization with bdShift1 54₁ and the final rounding 54₂ to the bit depth with bdShift2, needed by the transform, can be moved to the transform path 54. This would reduce the transform skip scaling to a downshift by 10-bit with rounding. In another embodiment, a bitstream restriction can be defined that does not allow an encoder to use QP values that result in a scaling factor of less than 1 for transform skip instead of clipping the QP value to 4. FIG. 7 shows an improved decoder-side scaling 52 and inverse transform 54 according the present invention.

At the other end of the bit-rate range, i.e. for lower bit rates, the quantization step size for the identity transform 1282 may be decreased by an offset, resulting in a higher fidelity for block that does not apply a transform or that does apply the identity transform 1282. This would enable the encoder to select appropriate QP values for transform skip blocks to achieve higher compression efficiency. This aspect is not limited to the identity transform/transform skip 1282, it can also be used to modify the QP for other transform types 1281 by an offset. An encoder would, e.g., determine this offset in a way that increases the coding efficiency, e.g. by maximizing perceived visual quality or minimizing objective distortion like a square error for a given bitrate, or by reducing the bitrate for a given quality/distortion. This (in terms of the applied criterion) optimal derivation from the slice QP depends, for example, on the content, bit-rate or complexity operation point, and further factors such as selected transform and transform block size. The present invention describes methods for signalling the QP offset for the case of multiple transforms. Without loss of generality, given two alternative transforms, a fixed QP offset may be transmitted by the encoder in a high-level syntax structure (such as sequence parameter set, picture parameter set, tile group header, slice header, or similar) for each of the two alternative transforms. Alternatively, the QP offset is, e.g., transmitted by the encoder for each transform block when the encoder has selected the alternative transform. A combination of the two approaches is the signalling of a basis QP offset in a high-level syntax structure and an additional offset for each transform block that uses the alternative transform. The offset can be a value that is added or subtracted to a basis QP or an index into a set of offset values. That set can be predefined or signalled in a high-level syntax structure.
In an embodiment of the invention, the QP offset relative to a basis QP for the identity transform is signaled in a high-level syntax structure, e.g on sequence, picture, tile group, tile, or slice level.
In another embodiment of the invention, the QP offset relative to a basis QP for the identity transform is signaled for each coding unit or predefined set of coding units.
In another embodiment of the invention, the QP offset relative to a basis QP, for the identity transform is signaled for each transform unit that applies the identity transform.

Another aspect of the present invention is the use of different scaling matrices for different transform types, e.g. identity transform/transform skip. Scaling matrices allow to scale every transform coefficient differently. This can be interpreted as a frequency-dependent weighting as transform coefficients typically relate to different spatial frequencies of the residual signal. Since the distribution of coefficients resulting from different transform types can differ, it is suggested to use different scaling matrices for different transform types. A special case of this is the identity transform, where the coefficients equal the residual samples which are not related to spatial frequencies. In that case frequency-weighted scaling is not beneficial and either separate spatially-weighted scaling matrices or no matrix-based scaling can be applied.

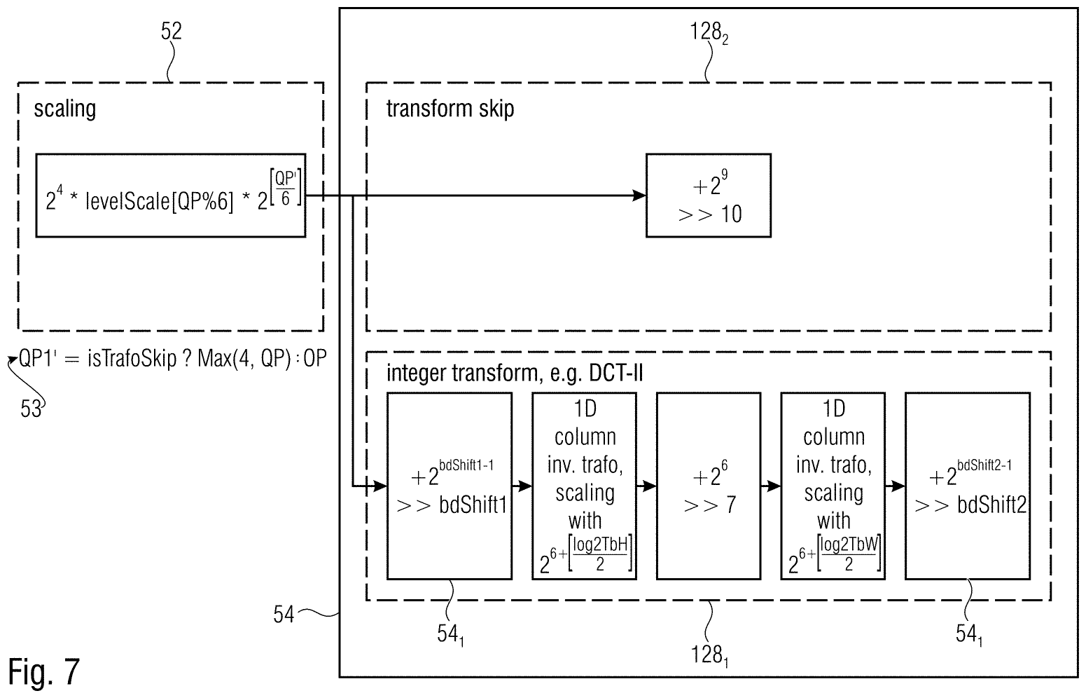

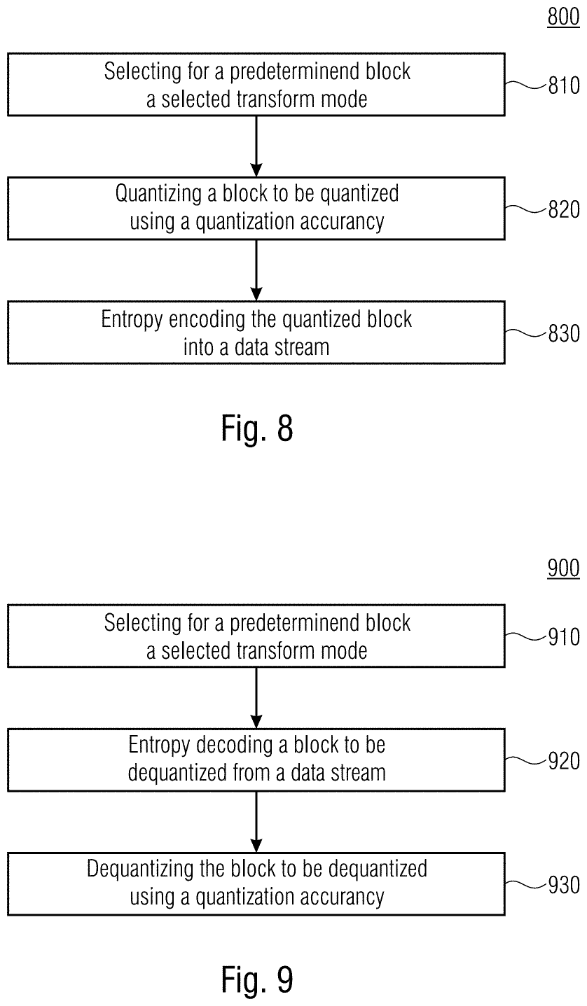

Furthermore, FIG. 8 and FIG. 9 show methods based on the principles described with regard to the encoder and/or decoder above.

FIG. 8 shows a method 800 for block-based encoding of a picture signal using transform coding, comprising selecting 810 for a predetermined block a selected transform mode, e.g. an identity transform or a non-identity transform, wherein the identity transform can be understood as a transform skip. Additionally, the method 800 comprises quantizing 820 a block to be quantized, e.g. the predetermined block subjected to the selected transform mode, which is associated with the predetermined block according to the selected transform mode, using a quantization accuracy, e.g. defined by a quantization parameter (QP), a scaling factor and/or a quantization step size, which quantization accuracy depends on the selected transform mode, to obtain a quantized block. The block to be quantized can be obtained by applying a transform underlying the selected transform mode onto the predetermined block, in case of the selected transform mode being a non-identity transform, and equalizing the predetermined block, in case of the selected transform mode being an identity transform. The quantizing 820 can be performed by dividing values of the block by the quantization parameter (QP), the scaling factor and/or the quantization step size to receive the quantized block. Additionally, the method 800 comprises entropy encoding 830 the quantized block into a data stream.

FIG. 9 shows a method 900 for block-based decoding of an encoded picture signal using transform decoding, comprising selecting 910 for a predetermined block, e.g. a residual block in an area of neighboring residual blocks in the decoded residual picture signal or residual video signal, a selected transform mode, e.g. an identity transform or a non-identity transform. The identity transform can be understood as a transform skip and the non-identity transform can be an inverse/reverse transformation of a transformation applied by an encoder or used by an encoding method. Additionally, the method 900 comprises entropy decoding 920 a block to be dequantized, e.g. the predetermined block before subjected to the selected transform mode, which block to be dequantized is associated with the predetermined block according to the selected transform mode, from a data stream. Furthermore, the method 900 comprises dequantizing 930 the block to be dequantized using a quantization accuracy, which depends on the selected transform mode, to obtain a dequantized block. The quantization accuracy can define an accuracy of the dequantization 930 of the block to be dequantized. The quantization accuracy, e.g., is defined by a quantization parameter (QP), a scaling factor and/or a quantization step size. The dequantizing 930 is, for example, performed by multiplying values of the block with the quantization parameter (QP), the scaling factor and/or the quantization step size to receive the dequantized block.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

1. Encoder for block-based encoding of a picture signal using transform coding, configured to:
select for a predetermined block a selected transform mode;
quantize a block to be quantized, which is associated with the predetermined block according to the selected transform mode, using a quantization accuracy, which depends on the selected transform mode, to acquire a quantized block; and
entropy encode the quantized block into a data stream.

2. Decoder for block-based decoding of an encoded picture signal using transform decoding, configured to:
select for a predetermined block a selected transform mode;
entropy decode a block to be dequantized, which is associated with the predetermined block according to the selected transform mode, from a data stream;
dequantize the block to be dequantized using a quantization accuracy, which depends on the selected transform mode, to acquire a dequantized block.

3. The decoder according to claim 2, wherein the quantization accuracy depends on whether the selected transform mode is an identity transform or a non-identity transform.

4. The decoder according to claim 3, configured to,
if the selected transform mode is the identity transform, determine an initial quantization accuracy for the predetermined block and check whether the initial quantization accuracy is finer than a predetermined threshold,
if the initial quantization accuracy is finer than the predetermined threshold, set the quantization accuracy to a default quantization accuracy.

5. The decoder according to claim 4, configured to, if the initial quantization accuracy is not finer than the predetermined threshold, use the initial quantization accuracy as the quantization accuracy.

6. The decoder according to claim 4, configured to determine the initial quantization accuracy by determining an index out of a dequantization parameter list.

7. The decoder according to claim 6, wherein the index points to a quantization parameter within the dequantization parameter list and is associated with, via a function equal for all quantization parameter in the dequantization parameter list, a quantization step size.

8. The decoder according to claim 6, configured to check whether the initial quantization accuracy is finer than the predetermined threshold by checking whether the index is smaller than a predetermined index value.

9. The decoder according to claim 4, wherein the dequantization of the block to be dequantized comprises a scaling followed by an integer dequantization and wherein the decoder is configured such that the predetermined threshold and/or the default quantization accuracy relate to a scaling factor of one.

10. The decoder according to claim 4, configured to determine the initial quantization accuracy for several blocks, comprising the predetermined block, such as a whole picture, comprising the predetermined block, for several pictures, comprising the predetermined block, or for a slice of a picture, which comprises the predetermined block.

11. The decoder according to claim 3, configured to read the selected transform mode out of the data stream.

12. The decoder according to claim 4, configured to read the initial quantization accuracy out of the data stream.

13. The decoder according to claim 2, wherein the predetermined block represents a block of a prediction residual of the picture signal to be block-based decoded.

14. The decoder according to claim 2, configured to determine an initial quantization accuracy for the predetermined block and modify the initial quantization accuracy, dependent on the selected transform mode.

15. The decoder according to claim 14, configured to perform the modifying of the initial quantization accuracy by offsetting the initial quantization accuracy using an offset value, dependent on the selected transform mode.

16. The decoder according to claim 14, configured to determine the initial quantization accuracy by determining an index out of a dequantization parameter list.

17. The decoder according to claim 16, wherein the index points to a quantization parameter within the dequantization parameter list and is associated with, via a function equal for all quantization parameter in the dequantization parameter list, a quantization step size.

18. The decoder according to claim 16, configured to modify the initial quantization accuracy by adding the offset value to the index or by subtracting the offset value from the index.

19. The decoder according to claim 16, wherein the dequantization of the block to be dequantized comprises a scaling followed by an integer dequantization and wherein the decoder is configured to modify the initial quantization accuracy by adding the offset value to the scaling factor or by subtracting the offset value from the scaling factor.

20. The decoder according to claim 16, configured to provide the modified initial quantization accuracy dependent on whether the selected transform mode is an identity transform or a non-identity transform.

21. The decoder according to claim 16, configured to, if the selected transform mode is the identity transform,
determine an initial quantization accuracy for the predetermined block and check whether the initial quantization accuracy is coarser than a predetermined threshold,
if the initial quantization accuracy is coarser than the predetermined threshold, modify the quantization accuracy using an offset value, dependent on the selected transform mode, such that a modified initial quantization accuracy is finer than the predetermined threshold.

22. The decoder according to claim 21, configured to,
if the initial quantization accuracy is not coarser than the predetermined threshold, not modify the quantization accuracy using the offset value, dependent on the selected transform mode.

23. The decoder according to claim 21, configured to, if the selected transform mode is a non-identity transform, not modify the initial quantization accuracy using the offset value.

24. The decoder according to claim 14, configured to determine the initial quantization accuracy for several blocks, comprising the predetermined block, such as a whole picture, comprising the predetermined block, for several pictures, comprising the predetermined block, or for a slice of a picture, which comprises the predetermined block.

25. The decoder according to claim 14, configured to determine the offset by using a rate-distortion optimization.

26. The decoder according to claim 15, configured to read the offset out of the data stream for several blocks, comprising the predetermined block, such as a whole picture, comprising the predetermined block, for several pictures, comprising the predetermined block, or for a slice of a picture, which comprises the predetermined block.

27. The decoder according to claim 2, wherein the dequantization of the block to be dequantized comprises a block-global scaling and a scaling with an intra-block-varying scaling matrix followed by an integer dequantization and wherein the decoder is configured to determine the intra-block-varying scaling matrix dependent on the selected transform mode.

28. The decoder according to claim 2, configured to determine the intra-block-varying scaling matrix so that the determination results in different intra-block-varying scaling matrices for different blocks to be dequantized, which are equal in size and shape.

29. The decoder according to claim 28, wherein the determination is such that the intra-block-varying scaling matrix determined for the different blocks to be dequantized, which are equal in size and shape, depends on the selected transform mode and the selected transform mode is unequal to an identity transform.

30. The decoder according to claim 2, configured to, if the selected transform mode is a non-identity transform, apply a reverse transform corresponding to the selected transform mode to the dequantized block to acquire the predetermined block; and
if the selected transform mode is an identity transform, the dequantized block is the predetermined block.

31. Method for block-based encoding of a picture signal using transform coding, comprising:
selecting for a predetermined block a selected transform mode;
quantizing a block to be quantized, which is associated with the predetermined block according to the selected transform mode, using a quantization accuracy, which depends on the selected transform mode, to acquire a quantized block; and
entropy encoding the quantized block into a data stream.

32. Method for block-based decoding of an encoded picture signal using transform decoding, comprising:
selecting for a predetermined block a selected transform mode;
entropy decoding a block to be dequantized, which is associated with the predetermined block according to the selected transform mode, from a data stream;
dequantizing the block to be dequantized using a quantization accuracy, which depends on the selected transform mode, to acquire a dequantized block.

33. A non-transitory digital storage medium having a computer program stored thereon to perform the method for block-based encoding of a picture signal using transform coding, comprising:
selecting for a predetermined block a selected transform mode;
quantizing a block to be quantized, which is associated with the predetermined block according to the selected transform mode, using a quantization accuracy, which depends on the selected transform mode, to acquire a quantized block; and
entropy encoding the quantized block into a data stream,
when said computer program is run by a computer.

34. A non-transitory digital storage medium having a computer program stored thereon to perform the method for block-based decoding of an encoded picture signal using transform decoding, comprising:
selecting for a predetermined block a selected transform mode;
entropy decoding a block to be dequantized, which is associated with the predetermined block according to the selected transform mode, from a data stream;
dequantizing the block to be dequantized using a quantization accuracy, which depends on the selected transform mode, to acquire a dequantized block,
when said computer program is run by a computer.

35. Data stream acquired by a method for block-based encoding of a picture signal using transform coding, comprising:
selecting for a predetermined block a selected transform mode;
quantizing a block to be quantized, which is associated with the predetermined block according to the selected transform mode, using a quantization accuracy, which depends on the selected transform mode, to acquire a quantized block; and
entropy encoding the quantized block into a data stream.

36. Data stream acquired by a method for block-based decoding of an encoded picture signal using transform decoding, comprising:
selecting for a predetermined block a selected transform mode;
entropy decoding a block to be dequantized, which is associated with the predetermined block according to the selected transform mode, from a data stream;
dequantizing the block to be dequantized using a quantization accuracy, which depends on the selected transform mode, to acquire a dequantized block.
